(19) United States
(12) Patent Application Publication
(10) Pub. No.: US 2011/0265121 A1
(43) Pub. Date: Oct. 27, 2011

(54) SERVICE PROCESSING METHOD AND SYSTEM IN CONTENT DISTRIBUTION NETWORK OF INTERACTIVE NETWORK TV

(75) Inventors: Hao Liu, Shenzhen, Guangdong Province (CN); Yu Liu, Shenzhen, Guangdong Province (CN); Yinlong Wang, Shenzhen, Guangdong Province (CN)

(73) Assignee: ZTE CORPORATION, Shenzhen, Guangdong Province (CN)

(21) Appl. No.: 13/141,478

(22) PCT Filed: Sep. 16, 2009
(86) PCT No.: PCT/CN2009/073980

§ 371 Date: Jun. 22, 2011

(30) Foreign Application Priority Data
Dec. 29, 2008 (CN) 200810241720.1

(51) Int. Cl. H04N 5/445; H04N 7/173

(52) U.S. Cl. 725/39; 725/109

(57) ABSTRACT

The present invention provides a service processing method and system in a content distribution network of an interactive network TV. The service processing method includes the following steps: a service processing manager receiving and processing a service acquisition request of a service requesting device, and allocating service processing agent(s) for the service requesting device according to a load balance strategy; and the service processing agent(s) providing service for the service requesting device. The service processing system includes a service processing manager and service processing agents, wherein the service processing agents are adapted to provide service for a service requesting device, and the service processing manager is adapted to receive and process a service acquisition request of a service requesting device, and allocate a service processing agent(s) for the service requesting device according to a load balance strategy. The present invention deconcentrates the pressure of the service processing system, prevents the system from probable breaking down due to heavy load, and thereby can improve the stability of the operation of the system.

### FIELD OF THE INVENTION

The present invention relates to the field of interactive network TV, and in particular, to a service processing method and system in a content distribution network of an interactive network TV.

### BACKGROUND OF THE INVENTION

In the communication technical field, an Internet Protocol TV (also referred to as Interactive Personal TV, IPTV), which is also known as interactive network TV, is an Internet-based multimedia communication technology. The IPTV, taking advantage of infrastructure of broadband network and taking household televisions or computers as the main terminal equipment, transmits television signals through the Internet Protocol (IP), to provide family users with a variety of interactive digital media services including TV.

A Content Distribution Network or Content Delivery Network (referred to as CDN) is a new network architecture, for distributing the content of service to a network “edge” which is closest to the users, so that the users could obtain the desired content at the nearest distance, which improves the operation efficiency of the system. The CDN can technically provide a comprehensive solution for the problem of backbone network congestion due to large scale of users' access and uneven distribution of servers, while improving the speed at which the users access streaming media services and shortening the response time for the users' requests.

At present, in the content distribution network of an IPTV system, along with the volume of services increasing, the treatment intensity of a Service Control Point (referred to as SCP) system is enhanced, which results in that the system architecture of the existing single-server apparatus faces with performance crisis.

### SUMMARY OF THE INVENTION

The present invention provides a service processing method and system in a content distribution network of an interactive network TV, so as to deconcentrate the pressure of the system and improve the stability of the operation of the system in the service processing in a content distribution network of the interactive network TV.

In order to solve the above technical problem, the present invention employs the technical solution as follows.

A service processing method in a content distribution network of an interactive network TV comprises the following steps:

A, a service processing manager receiving and processing a service acquisition request of a service requesting device, and allocating service processing agent(s) for the service requesting device according to a load balance strategy; and

B, the service processing agent(s) providing service for the service requesting device.

In step A, the process of the service processing manager allocating service processing agent(s) for the service requesting device according to a load balance strategy is performed in the following manner:

A1, the service processing manager checking the validity of the service requesting device, wherein for an invalid service requesting device, the service processing manager refuses its request, and for a valid service requesting device, the service processing manager carries out the next step; and

A2, the service processing manager checking available service processing agent(s), and allocating the available service processing agent(s) to the service requesting device according to the load balance strategy.

The load balance strategy is performed in the following manner:

A21, determining whether the service processing agent(s) to which the service requesting device belongs is available, wherein if yes, the service processing agent(s) to which the service requesting device belongs is added to a list of available service processing agents;

A22, determining whether the current service processing agent(s) of the service requesting device is available, wherein if yes, the current service processing agent(s) is added to the list of available service processing agents; and

A23, determining whether the other service processing agents are available, wherein if yes, the available service processing agents are sequentially added to the list of available service processing agents, in ascending sequence of the number of connections.

In step B, before providing service for the service requesting device, the service processing agent(s) checks the validity of the service requesting device, wherein for an invalid service requesting device, the service processing agent(s) refuses providing the service.

In the service processing method, the service requesting device is an electronic program guide platform (EPG), a content delivery network agent (CDN Agent) or other service requesting device.

In the service processing method, the initiating time of the service acquisition request of the service requesting device is the time when the device starts, when a period for the service acquisition request expires, or when it is detected that the current service processing agent(s) is abnormal.

The present invention also provides a service processing system in a content distribution network of an interactive network TV, including a service processing manager and service processing agents, wherein the service processing agents are adapted to provide service for a service requesting device, and the service processing manager is adapted to receive and process a service acquisition request of a service requesting device, and allocate a service processing agent(s) for the service requesting device according to a load balance strategy.

In the service processing system, the load balance strategy is performed in the following manner: determining whether the service processing agent(s) to which the service requesting device belongs is available wherein if yes, the service processing agent(s) to which the service requesting device belongs is added into a list of available service processing agents; determining whether the current service processing agent(s) of the service requesting device is available wherein if yes, the current service processing agent(s) is added to the list of available service processing agents; and determining whether the other service processing agents are available wherein if yes, the available service processing agents are sequentially added to the list of available service processing agents, in ascending sequence of the number of connections.

In the service processing system, the service requesting device is an electronic program guide platform (EPG), a content delivery network agent (CDN Agent) or other service requesting device.

In the service processing system, the initiating time of the service acquisition request of the service requesting device is the time when the device starts, when a period for the service acquisition request expires, or when it is detected that the current service processing agent(s) is abnormal.

In the present invention, the pressure of the service processing system is deconcentrated in the service processing, preventing the system from probable breaking down due to heavy load and thereby improving the stability of the operation of the system, which is achieved by the way that an architecture of the service processing manager and the service processing agent is established, wherein the manager accomplishes the load balance function of multiple agents under the management, processes a request of the service requesting device, and allocates available agent(s) for the service requesting device, while the agent(s) provides services to the service requesting device under the management of the manager.

### BRIEF DESCRIPTION OF THE ACCOMPANYING DRAWINGS

FIG. 1 is a structural diagram of the frame of the multiple CP sub-system of the content distribution network in the IPTV system according to an embodiment of the present invention;

FIG. 2 is a sequential chart of the flow of load balance of multiple CP Agents of the content distribution network in the IPTV system according to an embodiment of the present invention; and

FIG. 3 is a flow chart of load balance of multiple CP Agents of the content distribution network in the IPTV system according to an embodiment of the present invention.

### DETAILED DESCRIPTION OF THE EMBODIMENTS

The present invention is described in detail in conjunction with the accompanying drawings and the embodiments as follows.

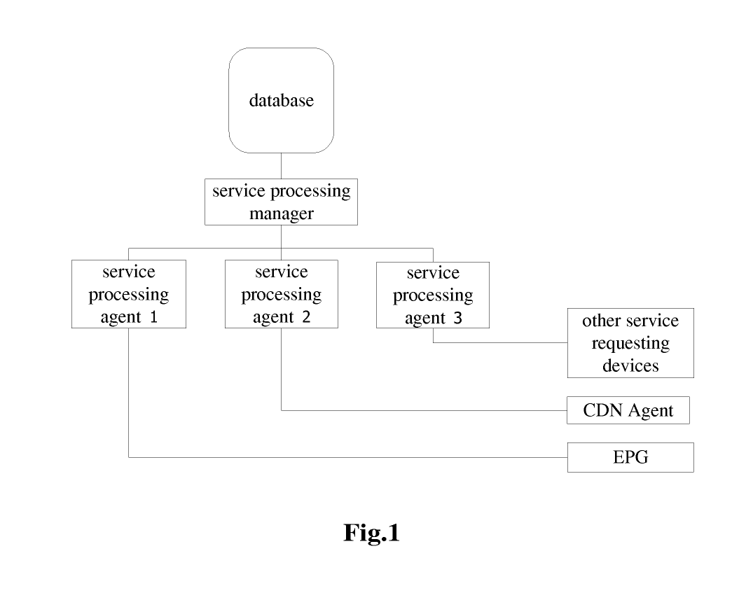

Referring to FIG. 1, the service control point (SCP) system (viz. the service processing system mentioned above) of the embodiments of the present invention mainly includes a service processing manager (CP Manager, viz. CP management terminal) and service processing agents (CP Agents, viz. CP service terminals), so as to provide services for a service requesting device (viz. client terminal), wherein the service requesting device can be an Electronic Program Guide Platform (referred to as EPG), a Content Delivery Network Agent (referred to as CDN Agent), or other service requesting device.

The CP Manager mainly accomplishes the load balance function of multiple CP Agents, viz. being responsible for checking the validity of the service requesting device and the state of the CP Agents in the system, allocating available CP Agent(s) for the service requesting device according to the load balance strategy, and updating the number of connections between the service requesting device and the CP Agent(s) in the system, so as to achieve the object of deconcentrating the pressure of the system.

A CP Agent mainly provides services for service requesting devices which obtain the present CP Agent through the CP Manager, and accomplishes, for these devices, service functions such as user login authentication, service authentication, billing and charging, Call Detail Record (referred to as CDR), user information synchronization and so on.

For the CP Manager and the CP Agent, the service requesting device is a client terminal. The service requesting device applies for CP Agent(s) from a CP Manager. The CP Manager allocates available CP Agent(s) for the device according to the load balance strategy, and simultaneously updates the number of connections of the service requesting devices of the related CP Agent(s). The service requesting device establishes connection(s) with the CP Agent(s) which is obtained by the application, and then the related requests of the service requesting device are all transmitted to the CP Agent(s) for processing. The CP Agent(s) provides services for the service requesting devices allocated through the CP Manager, and refuses providing services for the service requesting devices which are not allocated through the CP Manager.

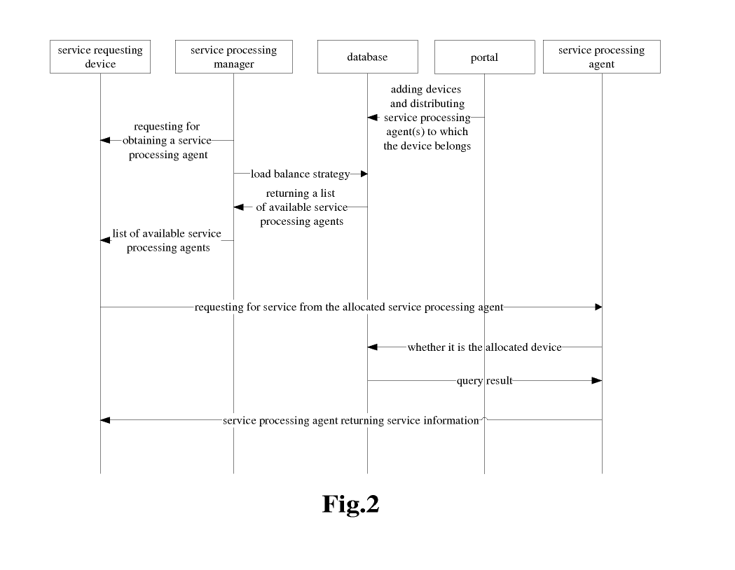

FIG. 2 is a sequential chart of the flow of load balance of multiple CP Agents of the content distribution network in the IPTV system according to an embodiment of the present invention, and the flow includes the steps as follows.

Step 1: when service requesting devices are added to a portal system, each service requesting device is configured with a CP Agent to which the service requesting device belongs.

Step 2: the service requesting device requests to obtain serving CP Agent(s) from the CP Manager in the following three cases, viz. the device starting, the period for obtaining the CP Agent(s) expiring, and it is detected that the allocated CP Agent is abnormal.

Step 3: the CP Manager receives a message of the service requesting device for requesting to obtain serving CP Agent(s), divides the request information, forms database information, and conducts a query in a database (referred to as DB) according to the database information; wherein the division of the request information is performed according to the service requesting device type (EPG, CDN Agent, and other devices), the service requesting device ID number, and the ID number(s) of the CP Agent(s) currently providing services, which are transmitted by the service requesting device.

Step 4: the CP Manager transmits a response to the service requesting device according to the result returned by the database, wherein the response includes information indicating whether there exists available CP Agent(s), the available CP Agent, or a list of available CP Agents.

Step 5: then the service requesting device requests all the related services from (only from) the CP Agent(s) allocated this time, so as to achieve the object of load balance.

In the above, step 3 includes the following steps:

step 3.1, the CP Manager checks, according to information such as a device identifier of the service requesting device, the validity of the device; and

step 3.2, for a valid device, a query for a list of available CP Agent(s) is conducted according to the load balance strategy.

In the above, step 4 includes the following steps:

step 4.1, according to the attribute of the service requesting device, an available CP Agent or a list of available CP Agents are returned to the service requesting device; and

step 4.2: the number of the service device connections of the original serving CP Agent(s) and the current serving CP Agent(s) of the device is updated.

In the above, step 5 includes the following steps:

step 5.1: the CP Agent(s) receives a service request message from the service requesting device and checks the validity of the device; and

step 5.2: if the device is invalid, viz. the device which is not allocated through the CP Manager to the CP Agent for obtaining services, the CP Agent(s) refuses providing a service for the device, otherwise, the CP Agent(s) provides a service for the device.

Correspondingly, step 3.2 further includes the following steps:

step 3.21, it is checked whether the CP Agent(s) to which the service requesting device belongs in the system is available, wherein if it is available, the CP Agent(s) to which the service requesting device belongs is added to the list of available CP Agents;

step 3.22, it is checked whether the current serving CP Agent(s) of the service requesting device in the system is available, wherein if it is available, the current serving CP Agent(s) is added to the list of available CP Agents; and

step 3.23, it is checked whether the other CP Agents in the system are available, and the available CP Agents are sequentially added to the list of available CP Agents, in ascending sequence of the number of the connections of the current serving device.

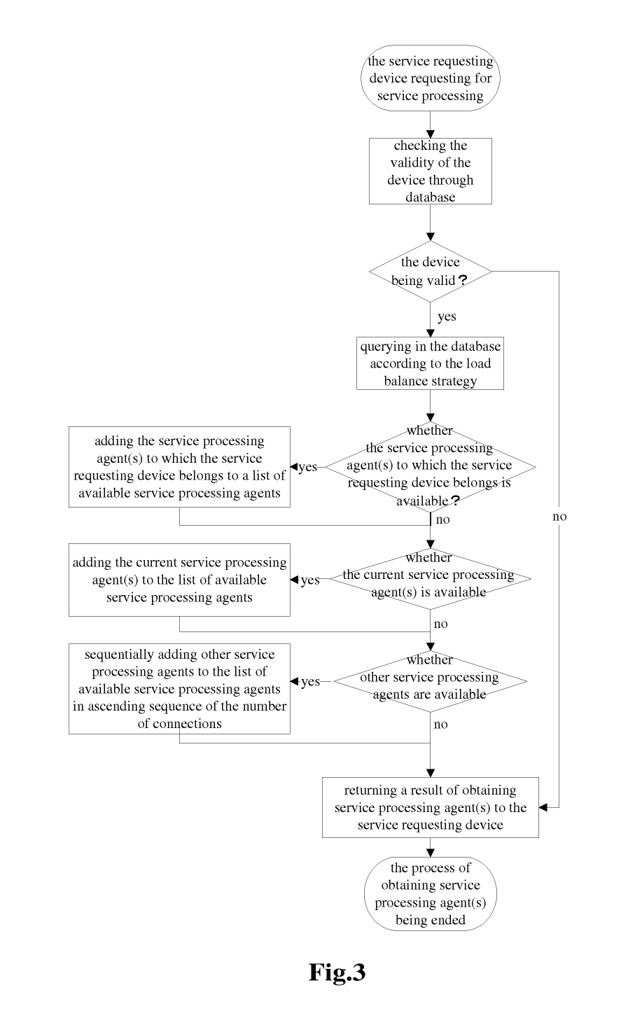

FIG. 3 is a flow chart of load balance of multiple CP Agents of the content distribution network in the IPTV system according to an embodiment of the present invention.

After receiving a request of applying for CP Agent(s) from the service requesting device, the CP Manager firstly checks the validity of the device, wherein if the device is invalid, the CP Manager directly transmits a message indicative of a failure of applying for CP Agent(s) to the device, and if the device is valid, the CP Manager allocates available CP Agent(s) to the device according to the load balance strategy. The flow of the load balance strategy is as follows:

Step 1: it is examined whether the CP Agent(s) to which the device belongs is available, wherein if it is available, the CP Agent(s) to which the device belongs is added to a list of available CP Agents;

Step 2: it is examined whether the current CP Agent(s) of the device is available, wherein if it is available, the current CP Agent(s) of the device is added to the list of available CP Agents;

Step 3: it is examined whether the other CP Agents in the system are available, wherein if they are available, the available CP Agents are sequentially added to the list of available CP Agents, in ascending sequence of the number of connections; and

finally, the result of obtaining the CP Agent(s) is returned to the service requesting device.

With regard to the CP system in the CDN network of the IPTV, the present invention employs the manner of the distributed load balance of the CP Agents and CP Manager to deconcentrate the pressure of the system, which avoids excessive burden of the system, and thereby improves the performance of the system. The CP Agent is not restricted by the region where it is located, and the services provided to the client can be performed by the CP Manager through the load balance, which can optimize the performance of the content distribution network, and highlight the advantages of the content distribution network.

The load balance is achieved by performing allocation through ascription, current, and load, which is easy to control, and can prevent allocation oscillation in case of abnormality, is more reasonable in strategy configuration. After the agents are allocated, if the client terminal requests for service from an agent which is not allocated reasonably, the agent will refuse providing service, which serves to protect against abnormality.

The present invention is applicable not only in the IPTV commercial systems, but also in other content distribution network-based systems such as monitor video and so on.

The above contents are detailed description on the present invention that is made in conjunction with preferable embodiments of the present invention, which are just examples serving to facilitate the understanding of the present invention, and shall not be construed as restrictions on the embodiment of the present invention. For those skilled in the art, the present invention may have various equivalent variations and substitutions without departure from the spirit of the present invention, and the variations and substitutions are all concluded in the scope of the present invention.

1. A service processing method in a content distribution network of an interactive network TV, the method comprising the following steps:
A, a service processing manager receiving and processing a service acquisition request of a service requesting device, and allocating service processing agent(s) for the service requesting device according to a load balance strategy; and
B, the service processing agent(s) providing service for the service requesting device.

2. The service processing method according to claim 1, wherein in step A, the process of the service processing manager allocating service processing agent(s) for the service requesting device according to a load balance strategy is performed in the following manner:
A1, the service processing manager checking the validity of the service requesting device, wherein for an invalid service requesting device, the service processing manager refuses its request, and for a valid service requesting device, the service processing manager carries out the next step; and
A2, the service processing manager checking available service processing agent(s), and allocating the available service processing agent(s) to the service requesting device according to the load balance strategy.

3. The service processing method according to claim 2, wherein the load balance strategy is performed in the following manner:
A21, determining whether the service processing agent(s) to which the service requesting device belongs is available, wherein if yes, the service processing agent(s) to which the service requesting device belongs is added to a list of available service processing agents;
A22, determining whether the current service processing agent(s) of the service requesting device is available, wherein if yes, the current service processing agent(s) is added to the list of available service processing agents; and
A23, determining whether the other service processing agents are available, wherein if yes, the available service processing agents are sequentially added to the list of available service processing agents, in ascending sequence of the number of connections.

4. The service processing method according to claim 1, wherein in step B, before providing service for the service requesting device, the service processing agent(s) checks the validity of the service requesting device, wherein for an invalid service requesting device, the service processing agent(s) refuses providing the service.

5. The service processing method according to claim 1, wherein the service requesting device is an electronic program guide platform (EPG), a content delivery network agent (CDN Agent) or other service requesting device.

6. The service processing method according to claim 1, wherein the initiating time of the service acquisition request of the service requesting device is the time when the device starts, when a period for the service acquisition request expires, or when it is detected that the current service processing agent(s) is abnormal.

7. A service processing system in a content distribution network of an interactive network TV, the system comprising a service processing manager and service processing agents, wherein the service processing agents are adapted to provide service for a service requesting device, and the service processing manager is adapted to receive and process a service acquisition request of a service requesting device, and allocate a service processing agent(s) for the service requesting device according to a load balance strategy.

8. The service processing system according to claim 7, wherein the load balance strategy is performed in the following manner: determining whether the service processing agent(s) to which the service requesting device belongs is available wherein if yes, the service processing agent(s) to which the service requesting device belongs is added into a list of available service processing agents; determining whether the current service processing agent(s) of the service requesting device is available wherein if yes, the current service processing agent(s) is added to the list of available service processing agents; and determining whether the other service processing agents are available wherein if yes, the available service processing agents are sequentially added to the list of available service processing agents, in ascending sequence of the number of connections.

9. The service processing system according to claim 7, wherein the service requesting device is an electronic program guide platform (EPG), a content delivery network agent (CDN Agent) or other service requesting device.

10. The service processing system according to claim 7, wherein the initiating time of the service acquisition request of the service requesting device is the time when the device starts, when a period for the service acquisition request expires, or when it is detected that the current service processing agent(s) is abnormal.

11. The service processing method according to claim 2, wherein the service requesting device is an electronic program guide platform (EPG), a content delivery network agent (CDN Agent) or other service requesting device.

12. The service processing method according to claim 3, wherein the service requesting device is an electronic program guide platform (EPG), a content delivery network agent (CDN Agent) or other service requesting device.

13. The service processing method according to claim 4, wherein the service requesting device is an electronic program guide platform (EPG), a content delivery network agent (CDN Agent) or other service requesting device.

14. The service processing method according to claim 2, wherein the initiating time of the service acquisition request of the service requesting device is the time when the device starts, when a period for the service acquisition request expires, or when it is detected that the current service processing agent(s) is abnormal.

15. The service processing method according to claim 3, wherein the initiating time of the service acquisition request of the service requesting device is the time when the device starts, when a period for the service acquisition request expires, or when it is detected that the current service processing agent(s) is abnormal.

16. The service processing method according to claim 4, wherein the initiating time of the service acquisition request of the service requesting device is the time when the device starts, when a period for the service acquisition request expires, or when it is detected that the current service processing agent(s) is abnormal.

17. The service processing system according to claim 8, wherein the service requesting device is an electronic program guide platform (EPG), a content delivery network agent (CDN Agent) or other service requesting device.

18. The service processing system according to claim 8, wherein the initiating time of the service acquisition request of the service requesting device is the time when the device starts, when a period for the service acquisition request expires, or when it is detected that the current service processing agent(s) is abnormal.
